(19) United States
(12) Patent Application Publication
(10) Pub. No.: US 2009/0080671 A1
(43) Pub. Date: Mar. 26, 2009

(54) METHOD AND DEVICE FOR CONTROLLING A NOISE PRODUCING COMPONENT

(75) Inventors: Andreas Kellner, Singapore (SG); Georg Kurz-Bauer, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,264

(22) PCT Filed: Oct. 20, 2005
(86) PCT No.: PCT/IB05/53446

§ 371 Date: Apr. 30, 2007

(30) Foreign Application Priority Data
Oct. 28, 2004 (EP) 04105375.2

(51) Int. Cl. H04R 3/02

(52) U.S. Cl. 381/73.1

(57) ABSTRACT

This invention relates to controlling a noise producing component, so that the noise disturbance is lowered when rendering an audio signal to a user. More specifically, this invention relates to a method and device that reads the audio signal output level and determines the output level variations, whereby the output level variations are used for controlling the noise producing component.

### FIELD OF THE INVENTION

This invention relates to controlling a noise producing component, so that the noise disturbance is lowered when rendering an audio signal to a user. More specifically, this invention relates to a method and device that reads the audio signal output level and determines the output level variations, whereby the output level variations are used for controlling the noise producing component.

### BACKGROUND

Components such as hard-disks and/or optical drives as well as cooling fans are examples of noise producing components that are used in devices such as computers. A particular problem of the cooling fans is that they are often turned on and left on during operation, which may cause the fan noise to interfere with e.g. the playing of music or a movie. This fan noise can be quite annoying, especially in quiet parts of the music or the movie. This annoyance is, however, lowered at louder parts. The same problem occurs when considering the input/output access to the hard-disk and/or optical drives, which also produces a disturbing noise, which can be very noticeable and annoying in quiet parts of the music or the movie.

U.S. Pat. No. 6,591,198 discloses a system including a processor and a microphone for controlling noise output in a device in response to the ambient noise level. This is done by measuring the ambient noise level by use of the microphone. Based thereon, the processor causes the noise output of the device to be changed in response to the ambient noise level. The problem with this invention is that the current ambient noise level is detected, and based thereon the output of the device is changed. This can cause problems, especially when the noise output may not tolerate to be lowered or shut down over a certain time period. This would be the case when the noise output is caused by a cooling fan, wherein shutting the cooling fan down could cause an overheating of the device.

U.S. Pat. No. 6,494,381 discloses a cooling fan control mechanism that is responsive to heat generated within the electronic device and/or semiconductor substrate as well as being responsive to the audio output of the electronic device. According to this invention, the cooling fan control mechanism is based on considering the current audio output level and the current device temperature to determine the speed of the cooling fan. Therefore, when the current audio output level is high, the speed of the cooling fan is high, and vice verse. When the current audio output level is low, the speed of the cooling fan is low. The problem with this invention is that since the current audio output level and current device temperatures are considered, it cannot guarantee that the disturbance due to the noise caused by the cooling fan is lowered. This can be noticeable where the noise output in the device is low over a long time period. To prevent an overheating within the device, the mechanism would be forced to increase the speed of the cooling fan, which would cause a corresponding disturbance.

### OBJECT AND SUMMARY OF THE INVENTION

It is an object of the invention to solve the before-mentioned problems.

In one aspect the present invention relates to a method of controlling a noise producing component, so that the noise disturbance perceived by a user is lowered when rendering an audio signal, the method comprising the steps of:

reading said audio signal, and based thereon determining the output level variations of said audio signal, and

utilizing said output level variations for controlling the noise producing component, whereby a low output level of said audio signal results in controlling said noise producing component so that noise from said noise producing component is lowered.

Thereby the noise from the noise producing component is controlled in accordance with the output level variations of the rendered audio signal, so that a decrease in the output level is followed by a lower noise, and vice verse. An increase in the output level is followed by higher noise. The result is that the produced noise is not audible to the user.

In an embodiment the noise producing component is a cooling fan, and the controlling comprises controlling the speed of the cooling fan.

Thereby the disturbance due to the fan noise can be lowered during playback. A specific example is a cooling fan being the noise component in a computer having an audio adapter for playing back audio signals. By analyzing the audio signal being rendered by the audio adapter before playing back the audio signal, the cooling fan can be controlled accordingly. This is performed in such a way that the speed of the cooling fan, and therefore the cooling performance, is low where the output level is low, and high where the output level is high. The result is that the cooling performance of the fan is maintained, but the operation is scheduled according to the output levels of the rendered audio signal. The noise producing component can, in addition to the cooling fan, comprise one or more noise producing components. It follows that the noise production of said components is scheduled according to the output levels of the rendered audio signal.

In an embodiment the method further comprises predicting the temperature in the surroundings of said cooling fan and also using said predicted temperature as a control parameter in controlling the speed of the cooling fan.

By using the predicted temperature parallel to the output level variations when controlling the cooling fan, a more precise controlling is obtained. As an example, the predicted temperature could indicate that maximum speed of the cooling fan at a high output level is not necessary, since the predicted temperature in the surroundings of the cooling fan is well below the maximum temperature limit.

In an embodiment the method further comprises the step of determining the frequency characteristics of the audio signal, and further utilizing said frequency characteristic for controlling the noise producing component.

As an example, where two audio signals have the same intensity, but different frequency, the noise disturbance can be different due to the frequency difference. Accordingly, where the frequency is high, the noise can be higher than where the frequency is low. Thereby a more precise controlling is obtained.

In an embodiment the noise producing component is a disc drive, and the controlling of the noise producing component comprises controlling the input/output (I/O) access to said disc drive.

Thereby the noise caused when accessing the disc drive can be lowered during playback. This is done by controlling the I/O access in accordance with the output level variations, i.e. where the output level is high, an I/O access is allowed, and vice verse. Where the output level is low, the I/O access is forbidden.

In an embodiment the noise producing component comprises two or more noise producing components.

Thereby, the noise created by said two or more components can be lowered during playback. As an example the controlling could comprise controlling said I/O access to said disc drive as well as the cooling performance in accordance with the output level variations. In this example, the cooling parameters are the fan speed and the I/O access, wherein the effect of the controlling is to maintain the temperature below an upper temperature limit and to avoid an underflow of data in a storage means.

In a further aspect the present invention relates to a computer readable medium having stored therein instructions for causing a processing unit to execute said method.

In one aspect the present invention relates to an audio device for controlling a noise producing component, so that when rendering an audio signal the noise disturbance perceived by a user is lowered, the device comprising:
means for reading said audio signal and based thereon determining the output level variations of said audio signal, and
processing means for utilizing said output level variations for controlling the noise producing component, whereby a low output level of said audio signal results in a controlling of said noise producing component so that the noise disturbance from said noise producing component is lowered.

Thereby the device controls the noise from the noise producing component in accordance with the output level variations of the rendered audio signal. The result is that the produced noise is not audible to the user.

### DESCRIPTION OF THE DRAWINGS

In the following the present invention, and in particular preferred embodiments thereof, will be described in more details in connection with the accompanying drawing in which:

FIG. 1 illustrates a schematic overview of an embodiment of an audio device according to the present invention;

FIG. 2 illustrates a flowchart of an embodiment of a method for controlling a noise producing component,

FIG. 3 illustrates a schematic overview of an embodiment of an audio device according to the present invention,

FIG. 4 illustrates a flowchart of an embodiment of a method for controlling a noise producing component,

FIG. 5 illustrates an example of how to control a noise producing component when rendering an audio signal to a user.

FIG. 6 shows another example of how to control a noise producing component when rendering an audio signal to a user.

### DESCRIPTION OF PREFERRED EMBODIMENTS

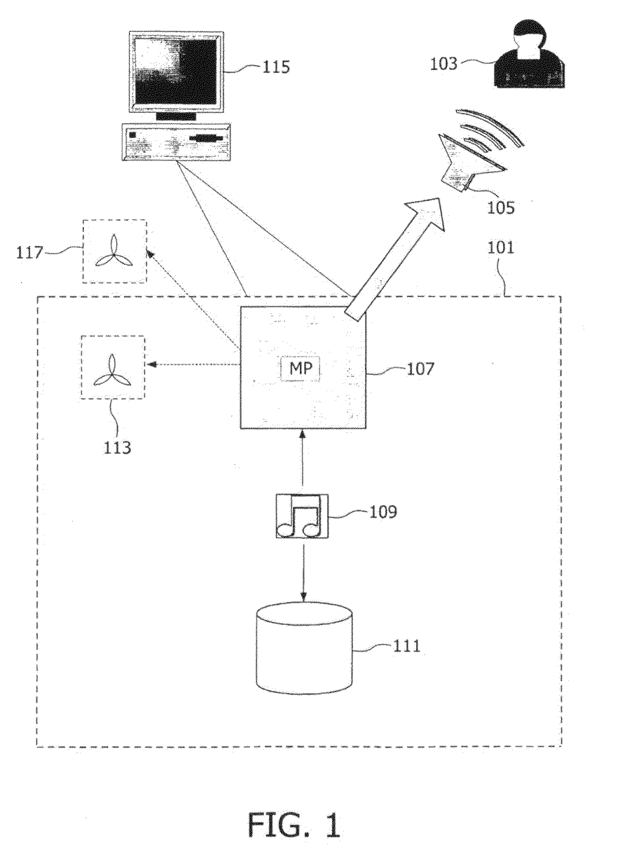

FIG. 1 illustrates a schematic overview of an embodiment of an audio device 101 according to the present invention comprising a microprocessor 107 and storage means 111. Shown is also a noise producing component, which can either be considered as an internal 113 or an external component 117 or a combination of both. Prior to rendering an audio signal 109 to a user 103, the audio signal 109 is read, decoded and stored in a storage means 111, wherein the storage means can be a FIFO buffer or the like. Subsequently, the output level variations of the audio signal 109 are determined. From the output level variations the acceptable noise level may be computed and used for controlling the noise producing components 113,117, using the processor 107. Here it is of course important to know the noise that is created by the noise producing components. This may be determined through measurements or the data may be obtained when purchasing the noise producing components. The controlling may be done in such a way that the produced noise is lowered in accordance with the low output level and increased where the output level of the audio signal is high. In this way an optimal schedule for the noise caused by the noise producing component 113,117 is determined, and the audio signal 105 can be rendered to the user 103 with a minimal disturbance. The read audio signal may comprise a predefined time interval, e.g. five minutes, so that a “schedule” is made five minutes in advance. The schedule is then updated five minutes later or earlier. The time interval may also be variable and be based on the current status of the storage means 111.

In the embodiment shown in FIG. 1 the audio device 101 is integrated into a computer 115 and used by the user 103, whereby the noise producing component is an internal component 113 of the computer 115. This can be a disc drive, and the produced noise is due to input/output (I/O) access to said drives. The I/O access to said drives is thereby controlled based on said output level variations, i.e. when the output level is high or exceeds a certain output level or a certain noise level, the access to the disc drive is permitted. Therefore it can be said that the controlling parameter is the I/O access and the effect of the controlling is to avoid an underflow in the storage means 111, while simultaneously lowering the noise that is created due to said I/O access.

In another embodiment the noise producing component is an external component 117, which is connected to the device 101. This external noise producing component 113 could as an example comprise an air condition system, a freezer, an external disc drive etc, where the noise produced is due to activating said devices.

In yet another embodiment the noise producing component comprises two or more components, which can be a combination of internal and external components.

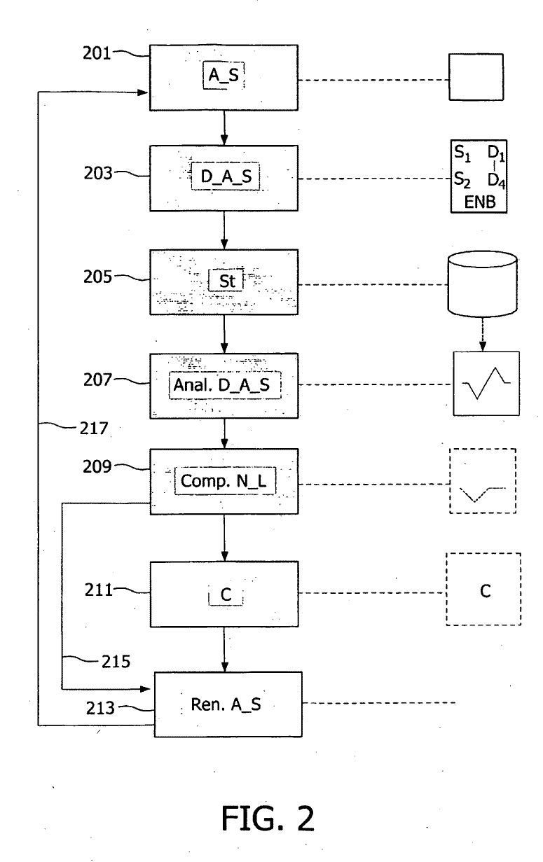

FIG. 2 illustrates a flowchart of an embodiment of a method for controlling a noise producing component, which we assume is a disc drive. The controlling parameter is therefore the I/O access and the effect of the controlling is to avoid an underflow in the storage means (i.e. to ensure that there are sufficient data in the storage means), so that that the noise disturbance due to the input/output access is lowered when rendering an audio signal to a user. The audio signal can be a movie or a song. Initially a predefined time interval of the audio signal is read in step 201 (A_S) decoded in step 203 (D_A_S) and stored in step 205 (St) prior to rendering it to the user. Thereby the decoded data 203 can be analyzed in step 207 (Anal. D_A_S) prior to the rendering. The analyzing comprises determining the output level variations of the audio signal over a certain time period in step 207 (An. D_A_S). As mentioned previously, the output level variations may be used to compute the acceptable noise level in step 209 (Comp. NIL), and based thereon the noise producing component is controlled 211 (C). In the case where the noise producing component is a disc drive, the controlling comprises controlling the input/output (I/O) access to said drives, so that when rendering the audio signal in step 213 (Ren. A_S) to the user, the disturbance due to said I/O access is lowered. Evidently, this comprises permitting access to the drives during louder or loud parts in the movie or the music that the user is listening to where the noise level is high, and prohibiting or minimizing the access during lower or low parts where the noise level is low. The term loud or louder and lower or low may be specific to the user, e.g. whether the user's hearing is good or not.

If the situation occurs that the controlling criteria can not be fulfilled, the audio signal 213 (Ren. A_S) will be rendered to the user 215 although it means that the noise will be noticeable. This can e.g. be to avoid an underflow in the memory 111. The before mentioned steps will now be repeated 217 for the next time interval.

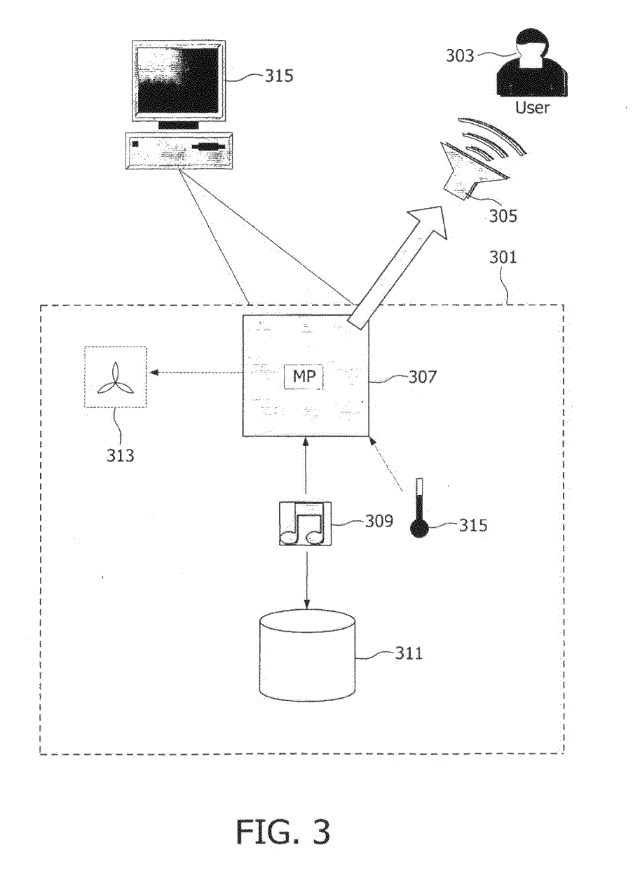

FIG. 3 illustrates a schematic overview of an embodiment of an audio device 301 for controlling a noise producing component using a microprocessor 307, so that the noise disturbance is lowered when rendering an audio signal 305 to a user 303. In this example the audio device is a part of a computer 315, and we assume that the noise producing component 313 is a cooling fan in the computer. Therefore, the control parameter is the fan speed of the cooling fan and the effect of the controlling is to ensure that the temperature within the computer 315 is below a given maximum temperature level and simultaneously to lower the noise disturbance. Other noise producing components are evidently also possible such as said internal 113 and/or external noise producing components shown in FIGS. 1 and 2. Simultaneously it is guaranteed that the temperature in the computer 315 will always stay below a given maximum value. Here it is of course important to know the noise created by the cooling fan 313 as a function of the fan speed. This information is something that can be measured or may be obtained when purchasing the cooling fan 313.

As described previously, the audio signal 309 is read, decoded and stored in a storage means 311 prior to rendering it to the user 303. The storage means can be a FIFO buffer or the like. Subsequently the output level variations of the audio signal 309 are determined and preferably used for computing the acceptable noise level. Based thereon the noise producing component 313 is controlled.

Further, the temperature output from the thermometer 315 may be read and used for predicting the temperature development in the computer 315. Based on the output level variations as well as the predicted temperature, the ventilator speed of the cooling fan 313 is controlled. The thermometer 315 may also be used to check whether the predicted temperature is correct or not, and thereby used for preventing a possible overheating within the computer 315. When predicting the temperature, a thermo dynamical model may be applied, taking the main heat source within the computer 315 into account and preferably also the ambient temperature. The predicted temperature may also be based on an empirical model for that specific type of computer 315. In this way an optimal schedule for the cooling is determined. As an example, a user 303 is listening to a song, which initially has a low output level, but thereafter a relatively high output level. The schedule or the controlling would then preferably comprise lowering the fan speed during the low output level, and just before a possible overheating occurs, which could occur during said low output level, maximizing the cooling performance. During the high output level the schedule would then possibly comprise a further cooling of the system, since the noise that is created due to the fan speed is not noticeable to the user 303.

In the case that in addition to the cooling fan 313 there is also one or more noise producing components to be controlled, e.g. said internal 113 and/or external 117 noise producing components shown in FIGS. 1 and 2, the controlling is additionally based on said additional noise producing components. As an example, if the noise producing components comprise the cooling fan 313 and a disc drive, the controlling is based on the speed of the cooling fan 313 (i.e. the cooling) and the I/O access to the disc drive. A preferred effect of this controlling is that the temperature of the computer is below a predetermined upper temperature limit, and simultaneously the I/O access to the disc drive is such that e.g. an underflow in the storage means 111 is avoided. As mentioned before, a situation may occur where the schedule or the controlling can not fulfill the criteria that the noise is below the acceptable noise level. In such a case the schedule would have to be disrupted, otherwise e.g. an overheating within the computer or an underflow in the storage means 111 may occur.

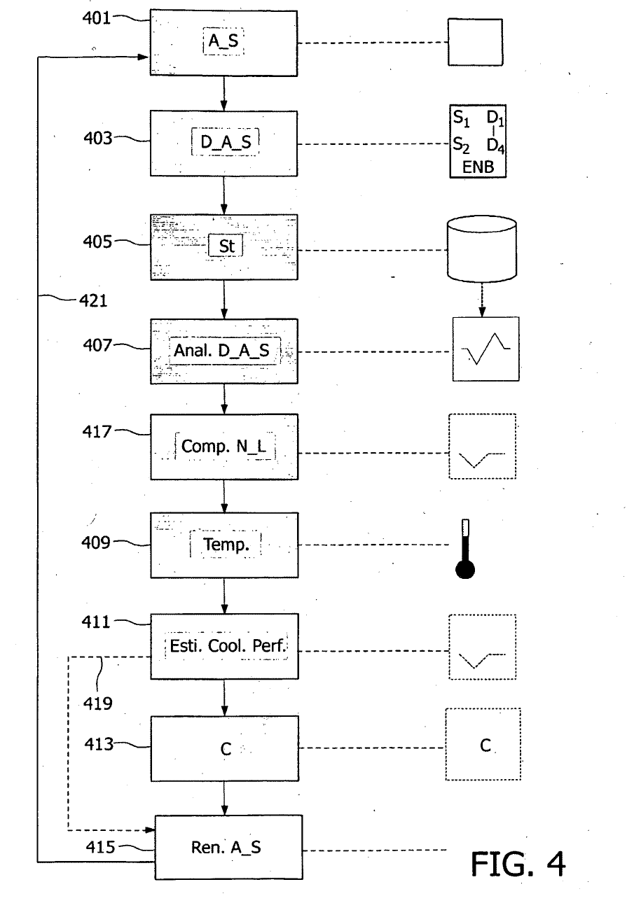

FIG. 4 illustrates a flowchart of an embodiment of a method for controlling a noise producing component, which can be a cooling fan, so that the noise disturbance from the cooling fan is lowered when rendering an audio signal to a user. As mentioned above, the noise producing components may comprise more than one producing component so that the controlling is a complex optimization problem. For simplicity, we however assume that the cooling fan is the only noise producing component. In that case the controlling parameter is only the fan speed, and the effect of the controlling is to maintain an optimal temperature in the surroundings of the cooling fan. We assume that the cooling fan is situated in a computer, which comprises an audio device. Initially the audio signal is rendered by the audio adapter in step 401 (A_S), decoded in step 403 (D_A_S) and stored (St) in step 405. The stored decoded data (D_A_S) 403 are analyzed in step 407 (Anal. D_A_S) over time, whereby the output level variations of the audio signal is determined over time in step 407 and preferably used for computing the acceptable noise level in step 417 (Comp. N_L). Further, the temperature in the computer may be measured, and the temperature development in the computer is preferably predicted in step 409 (Temp.). Based on the information relating to the output level variations of the audio signal over time in step 407, the acceptable noise level and the cooling performance is estimated in step 411 (Esti. Cool. Perf.). The measured temperature may be adapted to measure the initial temperature in the computer and also to check whether the predicted temperature is correct or not at some later time point, and thereby to prevent a possible overheating within the computer. Based on said information, the cooling fan is controlled in step 413 (C), and the audio signal is rendered in step 415 (Ren. A_S) to the user. Subsequently steps 401-419 are repeated 421.

As mentioned above, a situation may occur that the schedule or the controlling can not fulfill the criteria that the noise is below the acceptable noise level over a certain time period. In such a case the schedule or the controlling of the fan speed (or other noise producing component) must be disrupted or disregarded 419. The result in this example would be that the fan speed would be above the noise level limit. Otherwise an overheating within the computer may occur assuming that the noise producing component is the cooling fan.

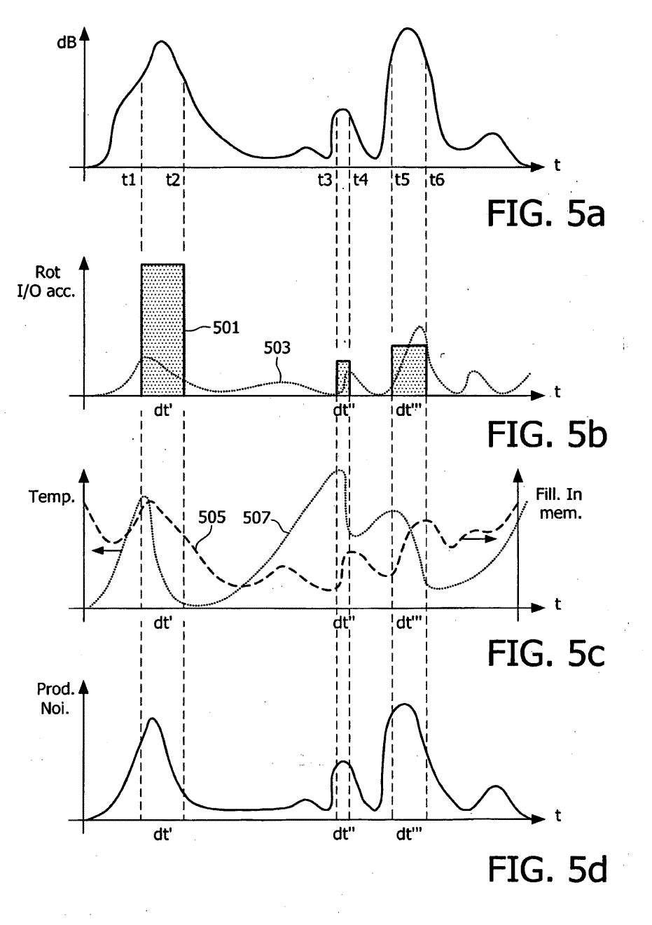

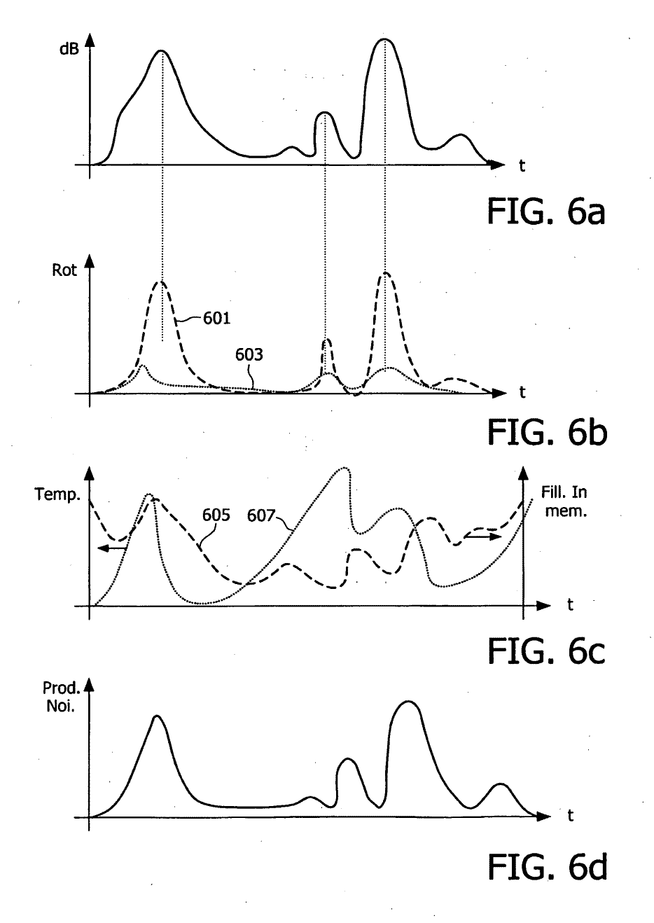

FIG. 5 illustrates an example of how to control a noise producing component when rendering an audio signal to a user. This example as well as the example in FIG. 6 are not based on actual data, but are merely for clarification. The diagram shown in FIG. 5a) illustrates an output level of an audio signal in decibels (dB) as a function of time t. Preferably, the output level is used to compute the acceptable noise level. The time period shown on the horizontal axis may represent a total duration of a song that the user is going to listen to or a time interval of that song. In this example the noise producing components are a cooling fan and I/O access to a disc drive. In order to enable the controlling of said noise producing components it is important to obtain information, which relate to the speed of the cooling fan and the I/O access to the disc drive to the created noise. One way of doing so is to simply measure the noise from the fan as a function of the speed and the noise created during I/O access to said disc drives. Also it would be possible to obtain such information when purchasing the fan and the disc drive. Having this information, the cooling fan and the I/O access to the disc drive may be controlled, so that the noise disturbance is lowered. In the embodiments described under FIGS. 1-4, the predicted temperature in the surroundings of the cooling fan may also be used as an additional controlling parameter.

FIG. 5b) shows one example of how to control the cooling fan according to the output level shown in FIG. 5a). The horizontal axis represents the same time line as shown in FIG. 5a), and the vertical axis is the rotational speed of the cooling fan and the noise due to the I/O access. Initially the cooling fan is not running. The curve 503 and the step function 501 represent a schedule for the I/O access to said disc drive and the ventilation speed of the cooling fan so that the noise created is lowered. In this example the ventilator speed is increased in a substantially stepwise way at time t1 as the output level reaches a certain noise level. This speed is maintained constant until at time t2, or for time interval dt′=t2−t1. Since the noise development shown in FIG. 5a) is such that the output level stays low for some time after reaching the first noise peak, it is important to obtain as much cooling performance as possible over time interval dt′. Otherwise an overheating can occur at a later time. As shown here, the second time the rotation speed is activated at time t3, but since the increase in the output level is relatively low, a low fan speed is allowed over a short time period, or dt″. However, since the initial cooling performance was very high, the temperature within the device may be well below a given maximum value. At time t5, where the output level increases again, the ventilator speed is increased, but not as much as at the beginning, since the temperature is/may still be well below the maximum value. This rotation speed is maintained constant over time period dt′″. Here it is ensured that over the entire time period the sum of noise created by the cooling fan and the ventilator is below an upper noise level, so that the disturbance is lowered when rendering the audio signal to the user.

FIG. 5c) and d) show the result of the schedule for the I/O access to said disc drive and the ventilation speed of the cooling fan. FIG. 5c) shows an example of an actual temperature curve 507 in the surroundings of the cooling fan, e.g. in a computer, and curve 505 represents the filling of data in the storage means. FIG. 5d) is the sum of the noise created due to the I/O access and the fan speed. By comparing the curve in FIG. 5d) with the one shown in FIG. 5a) it is preferred that the curve substantially follows the shape of the curve in FIG. 5a) and is below the acceptable noise level

FIG. 6 a) and b) show another example of how to control a noise producing component when rendering an audio signal to a user. Again, this example is not based on actual data, but is merely for clarification. In contrary to the stepwise increase in the ventilation speed as shown in FIG. 5b), the controlling of the cooling fan is based on controlling the rotational speed of the cooling fan, so that it substantially follows the shape of the output level curve 601. Also here is shown a corresponding curve for I/O access 603 to a disc drive or data processing. FIG. 6c) and d) show curves 605, 607 similar to the ones shown in FIG. 5c) and d).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for controlling a noise producing component (113,117), so that noise disturbance perceived by a user (103) is lowered when rendering an audio signal (109), the method comprising the steps of:
reading said audio signal and based thereon determining output level variations of said audio signal, and
utilizing said output level variations for controlling the noise producing component (113,117), wherein a low output level of said audio signal (109) results in a controlling of said noise producing component so that noise from said noise producing component (113,117) is lowered.

2. A method according to claim 1, wherein the noise producing component (113,117) is a cooling fan, and wherein the controlling comprises controlling speed of the cooling fan.

3. A method according to claim 2, further comprising predicting temperature in surroundings of said cooling fan and also using said predicted temperature as a control parameter in controlling speed of the cooling fan.

4. A method according to claim 1, wherein the method further comprises the step of determining frequency characteristics of the audio signal, and further utilizing said frequency characteristic for controlling the noise producing component (113,117).

5. A method according to claim 1, wherein the noise producing component (113,117) is a disc drive, and wherein the controlling of the noise producing component comprises controlling input/output access to said disc drive.

6. A method according to claim 1, wherein the noise producing component (113,117) comprises two or more noise producing components.

7. A computer readable medium having stored therein instructions for causing a processing unit to execute the method of claim 1.

8. An audio device (101) for controlling a noise producing component (113,117) so that when rendering an audio signal (109), noise disturbance perceived by a user (103) is lowered, the device comprising:
means for reading said audio signal and based thereon determining output level variations of said audio signal, and
processing means for utilizing said output level variations for controlling the noise producing component (113,117), wherein a low output level of said audio signal results in a controlling of said noise producing component (113,117), so that the noise disturbance from said noise producing component is lowered.
